(19) United States
(12) Patent Application Publication
(10) Pub. No.: US 2009/0160972 A1
(43) Pub. Date: Jun. 25, 2009

(54) DIGITAL IMAGE CAPTURING DEVICE AND IMAGE ACCESSING METHOD THEREOF

(75) Inventors: WEI-JEN WANG, Tu-Cheng (TW); SHIH-PAO CHENG, Tu-Cheng (TW)

Correspondence Address: PCE INDUSTRY, INC.;ATT. Steven Reiss, 458 E. LAMBERT ROAD, FULLERTON, CA, 92835, US

(73) Assignee: HON HAI PRECISION INDUSTRY CO., LTD., Tu-Cheng (TW)

(21) Appl. No.: 12/174,636

(22) Filed: Jul. 17, 2008

(30) Foreign Application Priority Data
Dec. 20, 2007 (CN) 200710203291.4

(51) Int. Cl. H04N 5/76; G06F 7/06; G06F 17/30; H04N 5/225

(52) U.S. Cl. 348/231.2; 707/3; 707/E17.014; 348/E05.024

(57) ABSTRACT

An image accessing method is disclosed. A search query view is firstly generated in response to a first user input. A time search query is secondly received by the search query view in response to a second user input. Exifs respectively associated the images are compared with the time search query to search image(s), if any, matching the time search query. Next, entry(s) associated with the searched image(s) is generated and displayed. Then, desired entry(s) is selected and thereby is accessed.

### BACKGROUND

1. Technical Field

The present invention relates to image capturing devices and, particularly, to a digital image capturing device and an image accessing method thereof.

2. Description of the Related Art

A digital camera typically has a secure digital (SD) card slot available for receiving a SD card therein. Standard SD card capacities range from 8 megabytes to 4 gigabytes, therefore, a great amount of images and videos can be stored in the SD card of the digital camera. However, being limited by display size, the digital cameras commonly enable users to browse only one photo at a time.

Therefore, it is desirable to provide a digital image capturing device and an image accessing method thereof, which can overcome the above-mentioned problem.

### SUMMARY

In an exemplary embodiment, an image accessing method is disclosed. A search query view is firstly generated in response to a first user input. A time search query is then received by the search query view in response to a second user input. Exchangeable image files (Exifs) respectively associated with the images are compared with the time search query to search image(s), if any, matching the time search query. Next, entry(s) associated with the searched image(s) is generated and displayed. Then, desired entry(s) is selected and thereby the corresponding image(s) is accessed.

### BRIEF DESCRIPTION OF THE DRAWING

Many aspects of the present digital image capturing device and image accessing method can be better understood with reference to the accompanying drawings. The components in the drawings are not necessarily drawn to scale, the emphasis instead being placed upon clearly illustrating the principles of the present digital image capturing device and image accessing method. Moreover, in the drawings, like reference numerals designate corresponding parts throughout the several views.

FIG. 1 is a functional block diagram of a digital still camera including a display panel, according to an exemplary embodiment.

FIG. 2 is a view of the display panel of FIG. 1.

FIG. 3 is another view of the display panel of FIG. 1.

FIG. 4 is a flowchart of an image accessing method, according to another exemplary embodiment.

### DETAILED DESCRIPTION OF THE EMBODIMENTS

Embodiments of the present digital image capturing device and image accessing method will now be described in detail with reference to the accompanying drawings. The digital image capturing device may be but not limited to a digital still camera (DSC) or a digital video camera. In the following described embodiments, the digital image capturing device is a DSC.

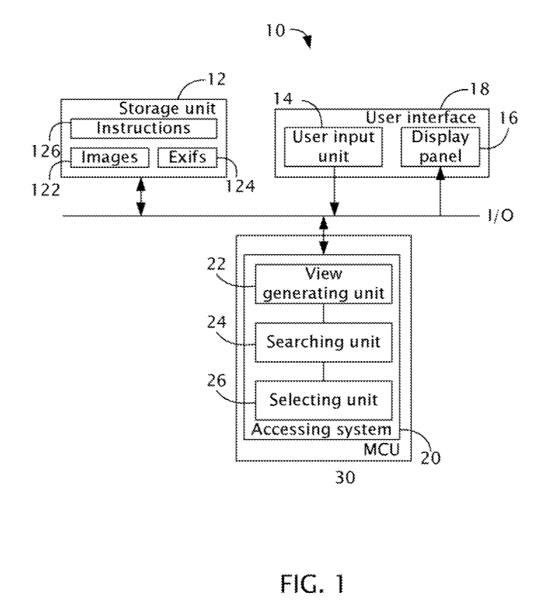

Referring to FIG. 1, a DSC 10, according to an exemplary embodiment, includes a storage unit 12, a user input unit 14, and a display panel 16. The storage unit 12 such as a memory card may have gigabytes in capacity for storing a great number of images 122. These images 122 are stored in conjunction with their corresponding Exifs 124. Each of the Exifs 124 may record parameters of a corresponding image such as timestamp, ISO value, aperture value, shutter speed, focal length, flash status, and scene. The timestamp is time information about when the associated image is captured. The user input unit 14 such as a keypad is configured for inputting. The display panel 16, such as a liquid crystal display panel, is configured for displaying information thereon. The user input unit 14 and the display panel 16 thereby constitute a user interface 18 for accessing desired image(s). In this embodiment, the input unit 14 and the display panel 16 are integrated into a touch screen, i.e., the user interface 18 is a touch screen. For the purpose of miniaturization, the size of the display panel 16 within the user interface 18 is typically small, e.g., smaller than 2.5 inch.

In addition to the storage unit 12, the user input unit 14, and the display panel 16, the DSC 10 further includes an accessing system 20. The accessing system 20 includes a view generating unit 22, a searching unit 24, and a selecting unit 26. In this embodiment, various components of the accessing system 20, such as the view generating unit 22, the searching unit 24, and the selecting unit 26 are realized as instructions 126 and stored in the storage unit 12. These instructions 126 may be written by a variety of programming languages such as C, C++, Java, Visual Basic and many others. The DSC 10 typically includes a micro control unit (MCU) 30. When the accessing system 20 is activated, the instructions 126 are loaded into the MCU 30 and executed to function as the described view generating unit 22, searching unit 24, and selecting unit 26. It should be understood that the components of the accessing system 20 is not limited by this embodiment, but can be individual chips or integrated into one chip.

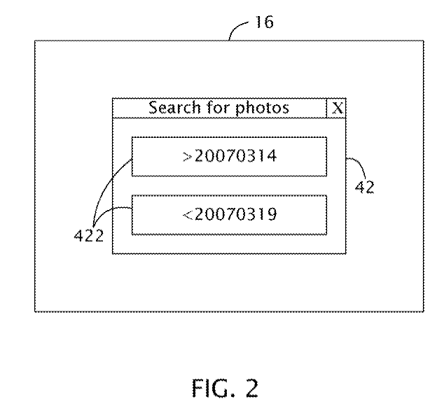

Referring to FIG. 2, the view generating unit 22 is configured for generating a search query view 42 on the display panel 16 in response to a first user input, e.g., a touch on a predetermined area of the display panel 16. This search query view 42 is configured for receiving a time search query corresponding to a second user input, e.g., symbols and numerical inputs. In particular, the search query view 42 may be a pop-up window in the display panel 16, including two fields 422. The fields 422 are capable of receiving sub-queries respectively and complete the time search query. For example, sub-queries, e.g., “>20070304” and “<20070319” are inputted, and form a time search query for searching image(s), for example, images captured between Mar. 4, 2007 and Mar. 19, 2007. It should be understood that the search query view 42 is flexible and can have different layouts.

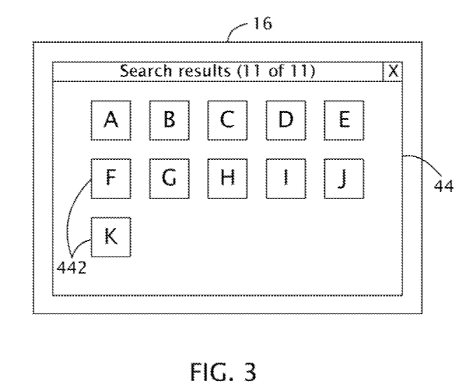

Referring to FIG. 3, the searching unit 24 is configured for searching image(s), if any, whose timestamp(s) match the time search query, and subsequently triggering the view generating unit 22 to display a list view 44 over the search query view 42. The list view 44 is configured for listing entry(s) 442 associated with the matched image(s). More specifically, the searching unit 24 compares the time search query with the timestamp of each image, instructs the view generating unit 22 to generate the list view 44, and generates the entry(s) 442, e.g., small-size icon(s), of the image(s) that satisfy the search query on the list view 44.

The selecting unit 26 is configured for selecting one or more listed entries in response to a third user input (e.g., a click or a touch on one desired entry), thereby accessing desired image(s) that is associated with the selected entry(s). The selecting unit 26 may also define a focus point on each selected entry to indicate which entry has been selected.

It should be understood that image(s) taken over a short period of time are typically in the same category, e.g., family members, campus activities, or office meetings. It is common that users may want to process, e.g., delete or encrypt, the images 122 by their categories. This can be efficiently accomplished by the DSC 10.

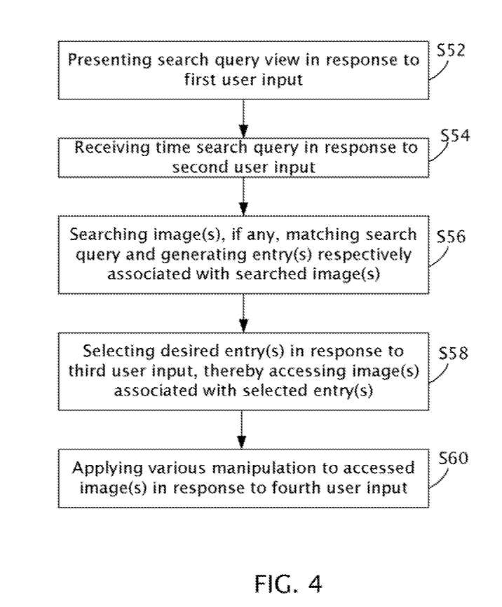

Also referring to FIG. 4, an image accessing method, according to another exemplary embodiment, includes the following steps 52-58. The image accessing method can be performed by, e.g., the DSC 10 after the accessing system 20 has been activated.

Step 52: presenting the search query view 42 in response to the first user input. This step can be carried out by the view generating unit 22, and the first user input can be performed by touching/contacting a predetermined area on the display panel 16.

Step 54: receiving the time search query in response to a second user input. This step is also carried out by the view generating unit 22.

Step 56: searching image(s), if any, matching the search query and generating entry(s) respectively associated with the searched image(s). This step can be carried out by the searching unit 24. In detail, after the time search query is received by the search query view 42, the searching unit 24 starts comparing the time search query with Exifs 124 associated with the images 122, instructs the view generating unit 22 to generate and display the list view 44 over the search query view 42, and generating entry(s) respectively associated with the image(s) that satisfy the time search query.

Step 58: selecting desired entry(s) in response to a third user input, thereby accessing the image(s) associated with the selected entry(s). This step can be carried out by the selecting unit 26.

Step 60: applying various manipulations, e.g., deletion or encryption, to the accessed image(s) in response to a fourth user input. These can be carried out by the MCU 30.

It will be understood that the above particular embodiments and methods are shown and described by way of illustration only. The principles and the features of the present invention may be employed in various and numerous embodiments thereof without departing from the scope of the invention as claimed. The above-described embodiments illustrate the scope of the invention but do not restrict the scope of the invention.

What is claimed is:

1. A digital image capturing device, comprising:
a storage unit configured for storing a plurality of images and corresponding exchangeable image files, the exchangeable image files comprising timestamps of the images;
a user input unit;
a display panel; and
an accessing system comprising:
a view generating unit configured for generating a search query view on the display panel in response to a first user input via the user input unit, the search query view being configured for receiving a time search query in response to a second user input via the user input unit;
a searching unit configured for comparing the time search query with the exchangeable image files to search image(s), if any, that match the time search query, instructing the view generating unit to generate and display a list view over the search query view, and generating entry(s) associated with the matched image(s) on the list view; and
a selecting unit configured for selecting desired entry(s) in response to a third user input via the user input unit, thereby accessing the selected entry(s).

2. The digital capturing device as claimed in claim 1, being one selected from the group consisting of digital still camera and digital video camera.

3. The digital still camera device as claimed in claim 1, wherein each of the exchangeable image files further comprises a parameter of the image selected from the group consisting of ISO value, Aperture value, Shutter speed, Focal length, Flash status and Scene.

4. The digital still camera device as claimed in claim 1, wherein the user input unit comprises a keypad.

5. The digital still camera device as claimed in claim 1, wherein the display panel comprises a liquid crystal display panel.

6. The digital still camera device as claimed in claim 1, wherein the user input unit and the display panel are integrated into a touch screen.

7. The digital still camera device as claimed in claim 6, wherein the first user input is a touch on a representation on the touch screen.

8. The digital still camera device as claimed in claim 6, wherein the third user input is a touch on an entry on the touch screen.

9. The digital still camera device as claimed in claim 1, wherein the search query view comprises a field for receiving the time search query.

10. The digital still camera device as claimed in claim 1, wherein the time search query is comparable in format with the timestamp of the images.

11. The digital still camera device as claimed in claim 1, wherein the second user input comprises a mathematical operator and a digit.

12. The digital still camera device as claimed in claim 1, wherein the entry(s) are small-size icon(s).

13. The digital still camera device as claimed in claim 1, wherein the selecting unit is configured for defining a focus point on each selected entry.

14. The digital still camera device as claimed in claim 1, wherein the accessing system further comprises a plurality of individual chips capable of realizing the component units in the accessing system.

15. The digital still camera device as claimed in claim 1, wherein the accessing system further comprises an integrated chip capable of realizing the component units in the accessing system.

16. The digital still camera device as claimed in claim 1, wherein the storage unit further stores instructions capable of helping realize the component units in the accessing system.

17. The digital still camera device as claimed in claim 16, wherein the instructions are written by a software language selected from the group consisting of: C, C++, Java and Visual Basic.

18. An image accessing method comprising:
presenting a search query view in response to a first user input;
receiving a time search query using the search query view in response to a second user input;
searching image(s), if any, by matching the time search query;
displaying a list view over the search query view, the list view being configured for listing entry(s) associated with image(s) that satisfy the time search query; and
selecting desired entry(s) thereby in response to a third user input, thereby accessing the selected entry(s).

19. An image accessing method of a digital still camera, the digital still camera comprising a plurality of images and corresponding exchangeable image files, the exchangeable image files comprising timestamps of the images, the image accessing method comprising:
generating a search query view in response to a first user input;
receiving a time search query using the search query view in response to a second user input;
comparing the time search query with each of the exchangeable image files to search image(s) whose timestamp(s) satisfy the time search query;
displaying a list view over the search query view;
generating entry(s) on the list view;
selecting desired entry(s) in response to a third user input, and accessing the selected entry(s).

20. The image accessing method as claimed in claim 19, further comprising applying a manipulation to the accessed image(s) in response to a fourth user input.
